(19) United States
(12) Patent Application Publication
(10) Pub. No.: US 2002/0040324 A1
(43) Pub. Date: Apr. 4, 2002

(54) System, method and computer program product for registering an unregistered vendor/product in a business-to- business network-based framework

(76) Inventors: Todd A. Dunning, Redwood Shores, CA (US); Brian A. Dunning, Orinda, CA (US); Anthony C. Wong, San Francisco, CA (US); John M. Chendo, San Francisco, CA (US); Sarah D. Timmons, Sunnyvale, CA (US); Charles S. Parsons, San Francisco, CA (US); Venkat Girish, Fremont, CA (US); Richard E. Hirshberg, Danville, CA (US); Igor Hamer, San Francisco, CA (US); Robert L. Honeycut, San Francisco, CA (US)

Correspondence Address: KEVIN J. ZILKA, P.O. BOX 721120, SAN JOSE, CA, 95172-1120, US

(21) Appl. No.: 09/767,646

(22) Filed: Jan. 22, 2001

Related U.S. Application Data
(63) Continuation-in-part of application No. 09/639,388, filed on Aug. 15, 2000.

(51) Int. Cl. G06F 17/60

(52) U.S. Cl. 705/26

(57) ABSTRACT

A system, method and computer program product are provided for registering an unregistered vendor in a network-based framework. Initially, at least one order is received from a first user utilizing a network. Such order is directed to a second user that is not registered with the network-based framework. There after, contact information of the second user is retrieved. A request is then transmitted to the second user using the contact information. Such request is for the second user to register with the network-based framework.

### FIELD OF THE INVENTION

The present application is a continuation-in-part of an application filed Aug. 15, 2000 under Ser. No. 09/639,388, which is incorporated herein by reference in its entirety.

### FIELD OF THE INVENTION

The present invention relates to e-commerce, and more particularly to business-to-business frameworks implemented utilizing the Internet.

### BACKGROUND OF THE INVENTION

The Internet has provided a relatively new medium on which many business-related services can now be offered. In the past, many businesses relied upon mobile storage devices, i.e. compact discs, floppy discs, etc., for disseminating information for various purposes. With the inception of wide use of the Internet, information may not only be disseminated in real-time, but also updated instantly. This environment has allowed many business-to-business related services to be offered on a grand scale.

FIG. 1 illustrates a framework 100 associated with one business-to-business model which is used to provide a public forum for merchants 102, or retailers, attempting to locate vendors 104, or manufacturers, for the purpose of placing and fulfilling orders. In use, the merchants 102 may browse various product lines 106 of products 108 offered by the vendors 104. To facilitate such searching, the product lines 106 of products 108 may be organized into categories 110 and sub-categories 112. For example, a vendor 104 may have a woodworking product line 106 including a Christmas nutcracker product 108 which may be found by searching under a houseware category 110 and an ornament sub-category 112.

Upon finding the desired product 108, inquiries and purchase orders 114 may be submitted from the merchants 102 to the vendors 104 for the purpose of reselling to customers. In exchange for the above services provided by the foregoing business-to-business framework 100, a fee is charged to the vendors 104 based on the value of the purchases. Such fee often comes in the form of a percentage of the fulfilled purchase order.

One problem that arises in the context of the framework 100 is due to the fact that the merchants 102 cannot always find a desired vendor 104 or product 108 when using the system. This is a result of the vendor 104 not registering with the framework 100, or a registered vendor 104 not properly registering a particular product 108. Often, this lack of registration is caused by the fee requirement associated with the use of the framework 100.

There is therefore a need for a computer implemented business method for registering unregistered vendors and/or products in a network-based business-to-business framework.

### DISCLOSURE OF THE INVENTION

A system, method and computer program product are provided for registering an unregistered vendor in a network-based framework. Initially, at least one order is received from a first user utilizing a network. Such order is directed to a second user that is not registered with the network-based framework. Thereafter, contact information of the second user is retrieved. A request is then transmitted to the second user using the contact information. Such request is for the second user to register with the network-based framework.

In one embodiment of the present invention, the first user may be a merchant and the second user may be a vendor. Further, the network may be the Internet. As an option, the first user may be allowed to complete a blank purchase order. Such purchase order may thus include the contact information used to send the request.

In another embodiment, a notification relating to the order may be sent. In particular, the notification may be sent if the second user fails to register. Optionally, the second user may be charged a fee based on the order. Further, the first user may be paid a rebate based on the order.

In another aspect of the present invention, a technique may be provided for registering unregistered goods or services in a network-based framework. Initially, at least one order for goods or services may be received from a first user utilizing a network. In the present embodiment, the goods or services are ordered from a second user, and are not registered with the network-based framework.

Thereafter, the second user is notified of the order utilizing the network. Further, the second user is permitted to display information on the goods or services using the network-based framework in response to the notification.

As an option, other users may be allowed to access information relating to the second user via the network. Such information is provided by the second user during the course of use of the various embodiments of the present invention, and may include contact information and/or information relating to goods or services offered by the second user.

In another embodiment of the present invention, the registration may include storing information relating to the second user in a database of the network-based framework. In use, such information in the database may be synchronized with information on a computing device which is connected to the database via the Internet.

### BRIEF DESCRIPTION OF THE DRAWINGS

FIG. 1 illustrates a framework associated with one business-to-business model which is used to provide a public forum for merchants attempting to locate vendors for the purpose of placing and fulfilling orders;

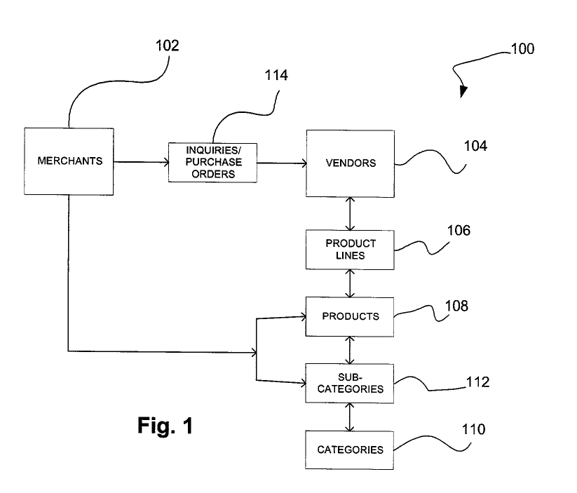

FIG. 2 illustrates a method for providing a rebate in a business-to-business network-based framework in accordance with one embodiment of the present invention;

FIG. 3 shows a representative hardware environment in which the foregoing method of FIG. 2 may be carried out;

FIG. 4 is a detailed flow diagram showing the various features of one embodiment of the present invention;

FIG. 5 shows an exemplary graphical user interface for displaying a current rebate rate, a current rebate amount, and the required money to be spent before receiving an incremental increase in the rebate rate based on a graduated scale, in accordance with one embodiment of the present invention;

FIG. 6 illustrates an exemplary graphical user interface that conveys information regarding the status of purchase orders and rebates;

FIG. 7 illustrates an exemplary graphical user interface explaining the various aspects of the rebate feature of the present invention;

FIG. 8 illustrates a method for allowing a merchant to purchase goods and/or services from a vendor who is not registered in the database of the present invention;

FIG. 9 illustrates a method for registering unregistered goods or services in a network-based framework in accordance with one embodiment of the present invention; and

FIG. 10 illustrates a system and method for catalog display and maintenance.

### DESCRIPTION OF THE PREFERRED EMBODIMENTS

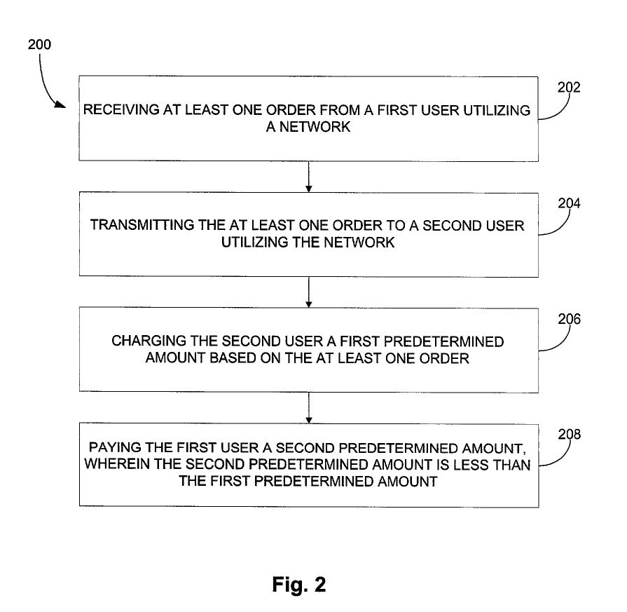

FIG. 2 illustrates a method 200 for providing a rebate in a business-to-business network-based framework in accordance with one embodiment of the present invention. As an option, the present invention may be implemented for a business-to-customer framework, or any other business model. Further, the rebate may take any form including, but not limited to a cash rebate. It should be noted that other value items such as coupons, discounts, or any other entities of value might also be provided.

Initially, in operation 202, at least one order is received from a first user utilizing a network. In one embodiment, the first user may take the form of a merchant, or retailer. It should be noted, however, that the first user may include any other type of desired party. Further, the order may be for any product or service desired. In various embodiments, the order may be received by way of an electronic message, an update on a website, or any other transmission mechanism over the network. The network may or may not include the Internet.

Thereafter, in operation 204, the at least one order is transmitted to a second user utilizing the network. In one embodiment, the second user may take the form of a vendor, or manufacturer. It should be noted, however, that the second user may include any other type of desired party. The order may be transmitted by any means similar to that by which the order was received.

As indicated in operation 206, the second user is further charged a first predetermined amount based on the at least one order. Such first predetermined amount may take any form including, but not limited to a percentage, flat fee, graduate fee, or any other value that is calculated as a function of the order(s). The first user is then paid a second predetermined amount in the form of a rebate. Note operation 208. In order to ensure positive revenue, the second predetermined amount is less than the first predetermined amount.

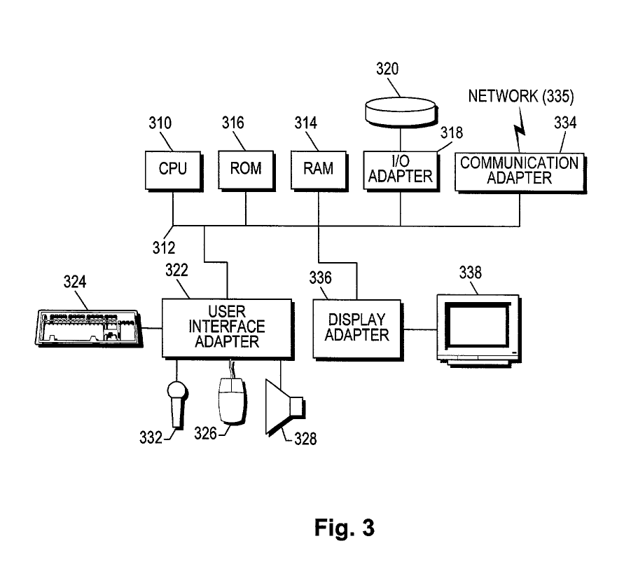

FIG. 3 shows a representative hardware environment in which the foregoing method 200 may be carried out. The hardware of environment of FIG. 3 may also be utilized by the first and second users in order to interface with the network-based framework. Such figure illustrates a typical hardware configuration of a workstation in accordance with a preferred embodiment having a central processing unit 310, such as a microprocessor, and a number of other units interconnected via a system bus 312.

The workstation shown in FIG. 3 includes a Random Access Memory (RAM) 314, Read Only Memory (ROM) 316, an I/O adapter 318 for connecting peripheral devices such as disk storage units 320 to the bus 312, a user interface adapter 322 for connecting a keyboard 324, a mouse 326, a speaker 328, a microphone 332, and/or other user interface devices such as a touch screen (not shown) to the bus 312, communication adapter 334 for connecting the workstation to a communication network 335 (e.g., a data processing network) and a display adapter 236 for connecting the bus 312 to a display device 338.

The workstation may have resident thereon an operating system such as the Microsoft Windows NT or Windows/95 Operating System (OS), the IBM OS/2 operating system, the MAC OS, or UNIX operating system. It will be appreciated that a preferred embodiment may also be implemented on platforms and operating systems other than those mentioned. A preferred embodiment may be written using JAVA, C, and/or C++ language, or other programming languages, along with an object oriented programming methodology. Object oriented programming (OOP) has become increasingly used to develop complex applications.

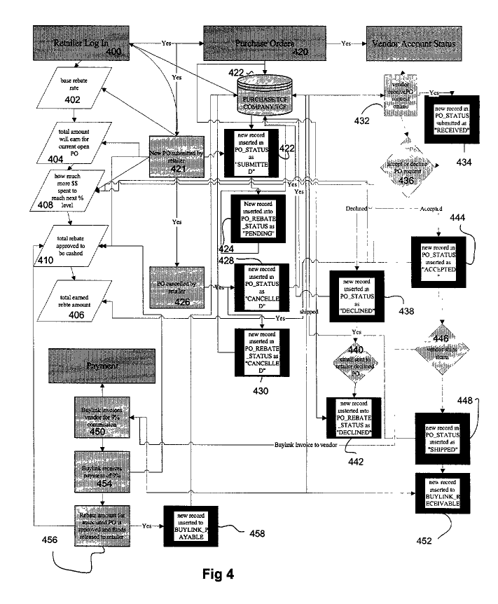

FIG. 4 is a detailed flow diagram showing the various features of one embodiment of the present invention. It should be noted that the network-based system of the present invention may take any form including, but not limited to a web-site, a P2P network, a distributed catalog content system, or any other system that is capable of carrying out the functionality set forth herein at least in part.

As shown in FIG. 4, a merchant, or retailer, may log in during operation 400. Initially, the merchant is assigned a base rebate rate in operation 402. Such rate may include a percentage of a total value, i.e. price, of a purchase order submitted by the merchant. In the alternative, the rate may include any other fee structure that is based on the purchase order submitted by the merchant.

As an option, the rebate percentage rate may change based on an amount of purchase orders that are submitted by the merchant. In other words, the rebate percentage rate may be selected based on a graduated scale governed by the value of a plurality of purchase orders. In the case where a merchant owns multiple stores, the rebate percentage rate may be based on the total value of purchase orders collectively made by the stores. In order to pay the above rebate percentage rates, the vendors may be charged another percentage rate that is greater than the rebate percentage rate.

The rebate percentage rate paid to the merchants may also be increased if the merchant referred the vendor, or other retailers. This feature work s to increase the pool of vendors and retailers. Conversely, any vendor that refers a retailer may be excused from the commission for purchases received from that retailer. In such case, the retailer may not get the rebate for the referring vendor, but the rebate percentage rate may still be calculated based on purchases from that particular vendor, in accordance with the graduated scale.

A sliding window may also be utilized in calculating the rebate percentage rate. In other words, the rebate percentage rate may be selected based on the value of the orders taken within a predetermined amount of time. In one embodiment, such predetermined amount of time is 60 days for inducing merchants to place orders timely. Equation 1 sets forth the formula associated with the rebate percentage rate, in accordance with one embodiment of the present invention.

### Equation 1

C_{R}=R[T in [L]]%+V%, where:

R=the rebate as a percentage defined in the look up table L.

L=the rebate-lookup table that defines the map between the total purchase amount and rebate accrued (See Table 2).

T=the total amount in purchase orders within the sliding window, i.e. 60 days.

V=the discount generated for a vendor that has been referred to by the merchant (applicable only for purchase order for that vendor).

As the merchant utilizes the present invention to submit purchase orders for various products from vendors, a current rebate rate and a total rebate amount are calculated and made available for display. Note operations 404 and 406, respectively. As an option, the total rebate amount may be differentiated from a total rebate approved to be cashed in operation 410. While the total rebate amount may be calculated based on purchase orders placed, the total rebate approved to be cashed may be calculated based on approved purchase orders. Table 1 sets forth various examples of statuses of approved purchase orders.

TABLE 1

| | |
|---|---|
| Submitted | Merchant has completed online |
| | purchase order and submitted the |
| | request to said vendor |
| Received | Purchase order has been viewed by |
| | vendor |
| Accepted | Purchase order request has been |
| | accepted by vendor |
| Shipped | Purchase order has been completed |
| | and shipped to merchant by vendor. |
| Closed | by vendor |
| Partially Shipped | Vendor has shipped part of the order |
| | to merchant |

Table 1a sets forth various examples of unapproved purchase orders.

TABLE 1a

Any purchase order placed prior to a predetermined date;
Purchase order declined by vendor; and
Purchase order cancelled by merchant, vendor, or representative of
the business-to-business framework.

In operation 408, a value of purchase orders required to receive an increased percentage may be calculated based on the graduated scale, and subsequently displayed. This information may be conveyed utilizing any desired graphical user interface. Table 2 illustrates an exemplary graduated scale.

TABLE 2

| Money Spent | Percentage of Savings |
|---|---|
| $0.00-999.00 = | 3% |
| $1,000-2,499 = | 4% |
| $2,500-4,999 = | 5% |
| $5,000-9,999 = | 6% |
| $10,000+ = | 7% |

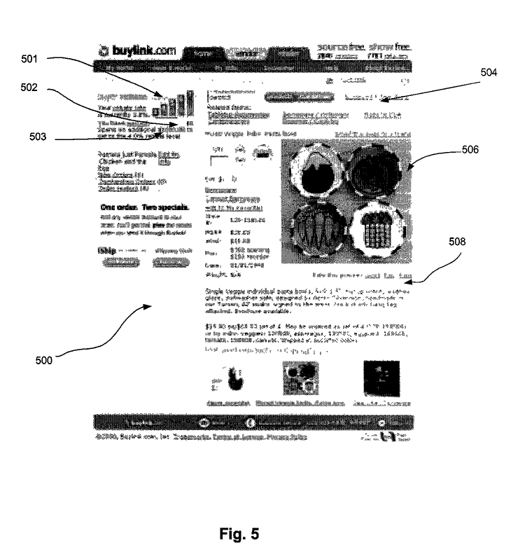

FIG. 5 shows one exemplary graphical user interface 500 for displaying a current rebate rate 501, a current rebate amount 502, and the required money to be spent 503 before receiving an incremental increase in the rebate rate based on a graduated scale (See Table 2), in accordance with one embodiment of the present invention. As mentioned earlier, such values are calculated in real-time as the merchant purchases products using the searching capabilities 504, display frames 506, and descriptions 508 provided by the present embodiment.

With continuing reference to FIG. 4, purchase orders and/or changes thereto may be received from the merchants in operation 420. Anytime changes are made to a purchase order, statistics in databases are refreshed to track a status of the purchase order using a “PO_STATUS” variable and any associated rebate using a “PO_REBATE_STATUS” variable.

When a purchase order is submitted by the merchant in operation 421, the PO_STATUS variable is assigned the with the status of “SUBMITTED”, and the PO_REBATE_STATUS variable is assigned with the status of “PENDING.” Note operations 422 and 424, respectively. If at any time the merchant cancels the purchase order in operation 426, the PO_STATUS variable and the PO_REBATE_STATUS variable are assigned with the status of “CANCELLED.” See operations 428 and 430. In one embodiment, the purchase order may be cancelled by the merchant only if the vendor has not received it.

Once the purchase order is received by the vendor in operation 432, the PO_STATUS variable is assigned with a “RECEIVED” status in operation 434. It is then determined in decision 436 as to whether the purchase order request is accepted or declined by the vendor.

If the purchase order is declined by the vendor in decision 436, the PO_STATUS variable is assigned with a “DECLINED” status in operation 438. Thereafter, an electronic mail message is sent to the merchant for notification purposes. Note operation 440. With the transmission of such message, the PO_REBATE_STATUS variable is assigned with the status of “DECLINED”, as indicated by operation 442. It should be noted that a comment field may be reserved for describing the nature of the declined statuses.

If, on the other hand, the purchase order is accepted by the vendor in decision 436, the PO_STATUS variable is assigned with an “ACCEPTED” status in operation 444. Thereafter, the vendor may ship the items in operation 446, and the PO_STATUS variable is assigned with a “SHIPPED” status. See operation 448.

At this point, the vendor is charged a first predetermined amount, i.e. 9% for commission in operation 450. The receipt of such commission is tracked in operation 452. Upon receipt of such commission in operation 454, the appropriate rebate amount may be transmitted to the merchant in operation 456. Ideally, the rebate is paid monthly, and only if it surpasses a predetermined amount (e.g. $25.00). The payment of rebates is also tracked, as indicated in operation 458.

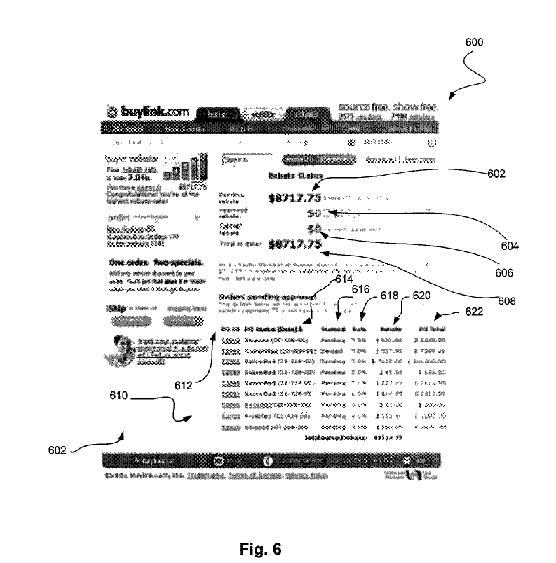

FIG. 6 illustrates a graphical user interface 600 that conveys information regarding the status of purchase orders and rebates. As shown, displayed is a pending rebate 602 that is calculated in operation 406 of FIG. 4. As mentioned earlier, such pending rebate 602 is subject to approval based on the status of the associated purchase order(s).

Below the pending rebate 602 is an approved rebate 604 that is calculated in operation 410 of FIG. 4. Further displayed is a cashed rebate 606 that represents approved rebates 604 that have been redeemed, i.e. checks cashed. A total rebate amount 608 is also calculated and displayed which represents the sum of the pending rebate 602, the approved rebate 604, and the cashed rebate 606.

With continuing reference to FIG. 6, a status of the pending rebates 602 is tracked in a list 610. Each pending rebate 602 is tracked by a purchase identifier 612. As shown, the current status 614 of the PO_STATUS variable is displayed next to each purchase identifier 612. Also shown is the current status 616 of the PO_REBATE_STATUS variable. The associated rate 618 is also displayed along with the associated rebate amount 620. Purchase order totals 622 are also shown.

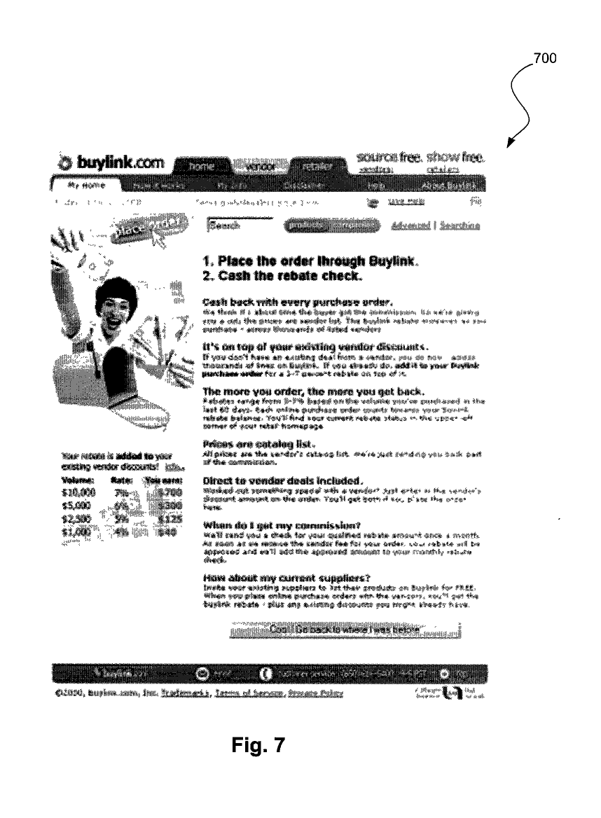

FIG. 7 illustrates an exemplary information page 700 explaining the various aspects of the rebate feature of the present invention. Such information page 700 aids merchants and vendors in utilizing the business-to-business framework of the present invention.

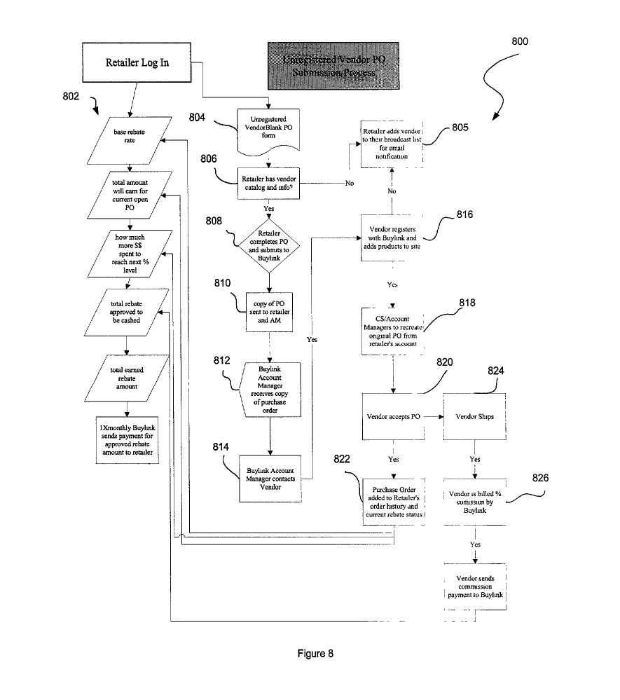

FIG. 8 illustrates a method 800 for allowing a merchant to purchase goods and/or services from a vendor who is not registered in the database 422 of the present invention. This functionality allows the merchant to increase its volume-based rebate amount while attracting additional vendor users. As shown in FIG. 8, the merchant information undergoes various operations 802 which correspond with operations 402-406 set forth during reference to FIG. 4.

When a merchant attempts to purchase goods and/or services from a vendor who is not registered in the database 422, he or she is provided with a blank purchase order in operation 804. It is then determined whether the merchant has a catalog and information that are necessary for obtaining the goods and/or services desired from the vendor. Note decision 806. As an option, this decision may be decided by simply querying the vendor.

If it is determined in decision 806 that the vendor does not have the catalog and information, the merchant may add the vendor to a list in the database 422. See operation 805. Using such list, the present invention is capable of transmitting a notification to the vendor. Such notification identifies goods and/or services desired by the merchant, thus giving the vendor an opportunity to respond with an offer to fulfill an order. Of course, the transmission of the notification may be accomplished using any desired communication medium, i.e. utilizing email, fax, wireless delivery, satellite transmission, etc.

If, on the other hand, it is determined in decision 806 that the vendor does have the catalog and information, the merchant may complete the blank purchase order. Thereafter, the completed purchase order may be submitted for inclusion in the database 422. Note operation 808. This may be accomplished using any desired communication medium, i.e. utilizing a network, etc.

Thus, if the merchant has the catalog information for the vendor who is not yet registered, they may manually fill in the purchase order information including, but not limited to vendor contact information, product details, quantity requested, cost and/or terms. As will soon become apparent, such purchase order request may be eligible for the volume-based rebate should the vendor accept the terms of the purchase and register.

Upon receipt of the completed purchase order, a copy of such purchase order is sent to both the merchant and the vendor, as indicated in operation 810. Again, this may be accomplished using any desired communication medium. In addition to the merchant and the vendor, such copy of the completed purchase order is also sent to a manager or person overseeing the database 422 in operation 812. This enables such person to contact the vendor for registration purposes via e-mail, fax, telephone, etc. Note operation 814.

At decision 816, the vendor has the ability to register with the database 422. If the vendor decides not to register, the merchant may add the vendor to the notification list in the database 422. See operation 805. If, however, the vendor decides to register in decision 816, database 422 personnel may re-create the purchase order that was filled out by the merchant. See operation 818. Registering may include receiving and storing contact and product information associated with the vendor, or any other information necessary for allowing the vendor to use the framework. Once registered, the vendor may include its products in the searchable database 422, and the various graphical user interfaces. Note FIG. 5.

If the vendor accepts the recreated purchase order in operation 820, the merchant is given credit by updating the various parameters in the database 422 that affect the new rebate amount. Note operation 822 of FIG. 8. Further, the vendor may ship the product in operation 824. As set forth earlier, the vendor is billed a first percentage in operation 826.

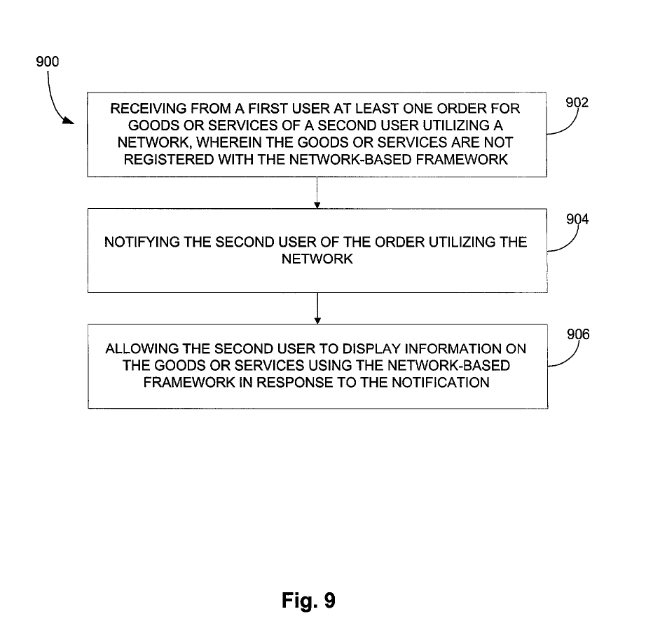

FIG. 9 illustrates a method for registering unregistered goods or services in a network-based framework in accordance with one embodiment of the present invention. It should be noted that a merchant may use merchant catalog information for identifying an unregistered product and/or service of a vendor who is already registered and present in the database 422. In particular, the retailer may add to their purchase order request such products that are not currently in the database 422. This functionality further allows the merchant to increase its volume-based rebate amount.

As shown in FIG. 9, a technique 900 is provided for registering unregistered goods or services in a network-based framework. Initially, in operation 902, at least one order for goods or services may be received from a first user, i.e. merchant, utilizing a network. As set forth hereinabove, the goods or services are ordered from a second user, and are not registered with the network-based framework. By being unregistered, the goods or services are not available using the framework 100.

Thereafter, in operation 904, the second user is notified of the order utilizing the network. Further, the second user is permitted to display information on the goods or services using the network-based framework in response to the notification. See operation 906. This may be accomplished by collecting information, i.e. pictures and/or specifications, on the goods or services for the purpose of displaying the same using the network-based framework 100. This allows other users to immediately access information relating to the second user via the network. Such information may include contact information and/or information relating to goods or services offered by the second user.

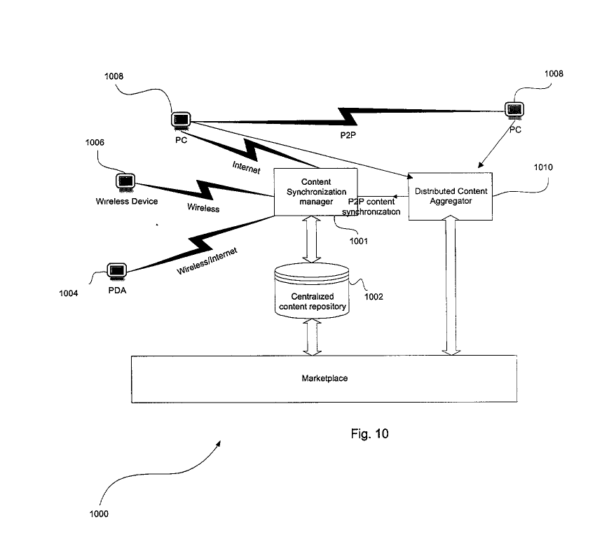

FIG. 10 illustrates a system and method 1000 for catalog display and maintenance. As set forth hereinabove, the database may be created and maintained at least in part by participating vendors. This not only removes any potential for data entry bottleneck, but it gives the vendors direct and immediate access and control over their own listings, 24 hours a day. As an option, various technologies may be employed to streamline this process even further, allowing direct automated synchronization between the database and whatever product database a vendor may already be using internally. To accomplish this, the information may be changed into a predetermined format or the like using a common interface protocol.

As shown in FIG. 10, the dynamic distributed catalog management system 1000 may include a centralized content repository 1002 which includes contact and product information of various vendors. Interfacing with the centralized content repository 1002 is a content synchronization manager 1001 which receives information from any type of computing device, i.e. personal digital assistant 1004, wireless device 1006, personal computer 1008, etc. Also included as a component of the dynamic distributed catalog management system 1000 is a distributed content aggregator 1010 which interfaces with the content synchronization manager 1001 and computing devices for purposes that will be set forth hereinafter.

In use, the content synchronization manager 1001 allows vendors to manage their contact and product information without being connected to a network such as the Internet. This is accomplished by storing and maintaining the contact and product information of each vendor in the centralized content repository 1002 and at least one of the computing devices. Maintenance may be carried out by synchronizing the contact and product information between the centralized content repository 1002 and the computing devices. This synchronization may be executed manually or automatically upon a connection being established between the computing device(s) and the centralized content repository 1002 via a network such as the Internet.

Entire catalogs may thus be managed off-line on vendors' computing devices, at their own convenience, and without bandwidth limitations. The content synchronization manager 1001 allows a vendor to “Instant sync” product information from the computing devices to the centralized content repository 1002 and vice-versa whenever the vendor is connected on-line.

As an option, software that affords the above functionality may be easy-to-use, point-and-click, and freely downloadable, thus requiring no computer expertise for the vendor to use. It may also make it dramatically more efficient to upload large numbers of files complete with photographs directly into the centralized content repository 1002. The system may also allow automatic importing of vendors' existing product data from MS EXCEL and many other standard database formats, and provide easy field mapping.

Optionally, the present embodiment may provide content management and synchronization support for vendors with electronic data interchange (EDI) catalogs. A distributed content aggregator 1010 may be adapted to aggregate content from vendor's websites. This allows vendors to maintain their own sites and allow the present embodiment to serve as a collaborative hub without any restrictions on participating vendors.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for registering an unregistered vendor in a network-based framework, comprising the steps of:
(a) receiving at least one order from a first user utilizing a network, wherein the at least one order is directed to a second user that is not registered with the network-based framework;
(b) getting contact information of the second user; and
(c) transmitting a request to the second user using the contact information, wherein the request is for the second user to register with the network-based framework.

2. The method as recited in claim 1, wherein the first user is a merchant and the second user is a vendor.

3. The method as recited in claim 1, wherein the network is the Internet.

4. The method as recited in claim 1, and further comprising the step of allowing the first user to complete a blank purchase order.

5. The method as recited in claim 4, wherein the purchase order includes the contact information.

6. The method as recited in claim 1, and further comprising the step of transmitting a notification relating to the order.

7. The method as recited in claim 6, wherein the notification is sent if the second user fails to register.

8. The method as recited in claim 1, and further comprising the steps of charging the second user a fee based on the order, and paying the first user a rebate based on the order.

9. The method as recited in claim 1, wherein the registration includes storing information relating to the second user in a database of the network-based framework, and other users are allowed to access the information.

10. The method as recited in claim 9, wherein the information in the database may be synchronized with information on a computing device which is connected to the database via the Internet.

11. A computer program product for registering an unregistered vendor in a network-based framework, comprising:
(a) computer code for receiving at least one order from a first user utilizing a network, wherein the at least one order is directed to a second user that is not registered with the network-based framework;
(b) computer code for getting contact information of the second user; and
(c) computer code for transmitting a request to the second user using the contact information, wherein the request is for the second user to register with the network-based framework.

12. The computer program product as recited in claim 10, wherein the first user is a merchant and the second user is a vendor.

13. The computer program product as recited in claim 10, wherein the network is the Internet.

14. The computer program product as recited in claim 10, and further comprising computer code for allowing the first user to complete a blank purchase order.

15. The computer program product as recited in claim 13, wherein the purchase order includes the contact information.

16. The computer program product as recited in claim 10, and further comprising computer code for transmitting a notification relating to the order.

17. The computer program product as recited in claim 15, wherein the notification is sent if the second user fails to register.

18. The computer program product as recited in claim 10, and further comprising computer code for charging the second user a fee based on the order, and paying the first user a rebate based on the order.

19. The computer program product as recited in claim 10, and further comprising computer code for allowing other users to access information relating to the second user.

20. The computer program product as recited in claim 10, wherein the registration includes storing information relating to the second user in a database of the network-based framework, and other users are allowed to access the information.

21. The computer program product as recited in claim 20, wherein the information in the database may be synchronized with information on a computing device which is connected to the database via the Internet.

22. A system for registering an unregistered vendor in a network-based framework, comprising:
(a) logic for receiving at least one order from a first user utilizing a network, wherein the at least one order is directed to a second user that is not registered with the network-based framework;
(b) logic for getting contact information of the second user; and
(c) logic for transmitting a request to the second user using the contact information, wherein the request is for the second user to register with the network-based framework.

23. A method for registering unregistered goods or services in a network-based framework, comprising the steps of:
(a) receiving from a first user at least one order for goods or services of a second user utilizing a network, wherein the goods or services are not registered with the network-based framework;
(b) notifying the second user of the order utilizing the network; and
(c) allowing the second user to display information on the goods or services using the network-based framework in response to the notification.

24. A computer program product for registering unregistered goods or services in a network-based framework, comprising:
(a) computer code for receiving from a first user at least one order for goods or services of a second user utilizing a network, wherein the goods or services are not registered with the network-based framework;
(b) computer code for notifying the second user of the order utilizing the network; and
(c) computer code for allowing the second user to display information on the goods or services using the network-based framework in response to the notification.

25. A system for registering unregistered goods or services in a network-based framework, comprising:
(a) logic for receiving from a first user at least one order for goods or services of a second user utilizing a network, wherein the goods or services are not registered with the network-based framework;
(b) logic for notifying the second user of the order utilizing the network; and
(c) logic for allowing the second user to display information on the goods or services using the network-based framework in response to the notification.
